(19) United States
(12) Patent Application Publication
(10) Pub. No.: US 2014/0081890 A1
(43) Pub. Date: Mar. 20, 2014

(54) Wealth information management system

(71) Applicant: Sherilyn I. Casiano, New York, NY (US)

(72) Inventor: Sherilyn I. Casiano, New York, NY (US)

(21) Appl. No.: 12/798,209

(22) Filed: Mar. 31, 2010

(51) Int. Cl. G06Q 40/06; G06Q 40/00

(52) U.S. Cl. CPC G06Q 40/06; G06Q 40/10
USPC 705/36 T

(57) ABSTRACT

This invention is generally directed to methods, systems and computer program products for wealth information management. Specifically, methods, systems and computer program products for the retrieval, compilation, collection, aggregation and analysis of an individual's or entity's financial and transactional data. The methods, systems and computer program products of the present invention will also be directed to creating an individual's or entity's commitment schedule, capturing an individual's transactional information and data, determining tax impacts while also determining relationships between transactions and discrepancies within the data.

### CROSS-REFERENCE TO RELATED APPLICATIONS

This application claims the benefit of, and is related to, the following Applicant's provisional patent application: U.S. Provisional Patent Application No. 61/211,404 titled “WEALTH INFORMATION MANAGEMENT SYSTEM,” filed Mar. 30, 2009.

### BACKGROUND OF THE INVENTION

### Field of the Invention

This invention is generally directed to methods, systems and computer program products for wealth information management. Specifically, methods, systems and computer program products for the compilation, collection, aggregation and analysis of an individual's or entity's financial and transactional data. The methods, systems and computer program products of the present invention will also be directed to capturing an individual's transactional information and data while determining relationships between transactions.

Currently, offices or entities that manage wealth utilize more than one platform to capture and compile an individual's financial and transactional data. There is no single platform that captures all financial and statistical data collected and managed for clients. This results in an inefficient, time-consuming and duplicative process. In addition, current systems fail to correlate or determine the relationships between transactions either conducted by the individual/client or on behalf of the individual/client. As a result, certain information remains or ends up being unreported—a situation which subsequently leads to inaccurate reporting. Thus, there is a need for a single more efficient method, system and computer program product for the compilation, collection, aggregation and analysis of data and client transactions for more accurate wealth information management.

### BRIEF DESCRIPTION OF THE INVENTION

The present invention meets the above-identified needs by providing a single platform system which allows for the compilation, collection, aggregation and analysis of clients' financial, statistical and transactional data. An aspect of an embodiment of the present invention allows for the generation of multiple report formats and analyses of asset performance (including Return-on Investment (ROI) of portfolios, change of basis and value in private equity investments, change of operating cost and value of real estate assets, etc.) In one aspect of an embodiment of the present invention, the data collection operation which unifies the data collection under one platform may be done manually or automatically by scheduled automatic downloads by the system. In another aspect of the present invention, the information or data capture may not lend itself merely to downloads but by intelligent querying undertaken by the system according to an embodiment of the present invention. The queries may involve questioning about a client's insurance policy, mortgage, ownership, whether they own or rent real property, detailed information concerning purchases and transactions etc. In another aspect of an embodiment of the present invention, data collected is analyzed to determine whether it is in an acceptable format. Where the data is not in an acceptable format, the system, according to an embodiment of the present invention, converts the data into an acceptable format. The present invention further ensures the accuracy and integrity of financial and asset activity by querying either system operator/users or the system for relationships between client transactions, determining the relationships between transactions based upon predetermined parameters (which may be determined by system operators or developed logically by the system) or by way of calculations or deductions done by the system (by system software and/or hardware) according to another embodiment of the invention. As a result, for example, the system according to an embodiment of the present invention in dealing with real property will query the operator/user about the property's mortgage, insurance, terms etc. In an investment transaction questions asked may include those regarding the commitment schedule and its terms. For rental property owned by the client, queries may include those regarding the rental property's rent rolls, operating expenses, etc. Here, the system, according to an aspect of an embodiment of the present invention, may set up different accounts as needed for the client's owned properties.

The primary benefit of this system is the comprehensive capture of real time data and the ability to identify missing or incomplete data sooner rather than later. The client benefits from the system in numerous ways including cash savings, time savings and reduced risk of loss of assets due to improper accounting or record management. Furthermore, the present invention ensures increased data collection and efficiency in reporting while allowing for better reporting/analyses formats and data aggregation.

### DETAILED DESCRIPTION

Aspects of the present invention are directed to efficient real-time wealth management using a computer data system as it relates to the compilation, collection, aggregation and analysis of clients' financial, statistical and transactional data.

In an aspect of the present invention, methods and computer program products perform the steps of retrieving client financial data from one or more sources, aggregating client financial data from one or more sources, reconciling client financial data, collecting data concerning one or more client transactions, creating a client commitment schedule, querying for additional information concerning a client transaction, analyzing the aggregated client financial data, determining relationships between client transactions and determining the format of the aggregated data. A commitment schedule may be an obligatory schedule or timetable of payment undertaken or imposed upon an individual for an asset or an investment. The individual may make a commitment to invest a certain amount over a defined period of time thereby modifying the schedule by deducting the amount paid out from the original total. In one aspect of the present invention, this may be sent out to potential investors as a private equity placement memo, which would outline how much each partner has to commit to. Such a private equity fund would track how much each partner committed to, amount paid thus far and the balance remaining. In another aspect of the present invention, if there is a payout, the system will locate or alert the operator/user that there should be a corresponding transaction for the payout somewhere else. For example, if there is a payout from the client's bank account, a corresponding transaction may be a reduction of the client's commitment schedule.

In another aspect of the present invention, the creation of the commitment schedule may involve determining a new balance for the client. This may include determining, recording and tracking the client's obligation for the commitment along with the payment terms (payment schedule, period of payments, etc.) The analysis of the aggregated client financial data may involve determining the return of investment of a client's investment portfolio. In another aspect of the present invention, the analysis of the aggregated client financial data may involve determining the change of basis and value of a client's investments.

In another aspect of the present invention, methods and computer program products perform the step of adjusting the commitment schedule.

In another aspect of the present invention, the relationships between transactions may be determined by analyses based on predetermined parameters. These parameters may be entered or may be developed by the system based on previous iterations of the system. The system, according to an aspect of the present invention, may prevent an operator/user from arbitrarily entering data without linking such data or associating it with a transaction.

In another aspect of the present invention, the relationships between transactions may be determined by linking newly flagged transactions with previously flagged transactions. For instance, when a client purchases a vehicle for his business, such a transaction may be identified or tagged as a “vehicular transaction”. Any subsequent transaction that may be related to the purchased vehicle, for instance, automobile insurance, will then be identified or tagged as a “vehicular transaction.” This ensures that all related transactions are entered, tracked and recorded properly. In another aspect, the classification may be accomplished by way of different transactional codes for each asset and/or transaction.

In another aspect of the present invention, methods and computer program products perform the step of transforming the aggregated client data into a standardized format where the data is not in a standardized format.

In another aspect of the present invention, methods and computer program products perform the step of generating one or more reports based on the aggregated data. A variety of reports may be generated including, but not limited to, annual transactional activity reports, investment portfolio reports, client commitment schedule reports, debt repayment reports, etc.

In another aspect of the present invention, methods and computer program products perform the step of determining the types of assets involved in the aggregated data. In another aspect of the present invention, methods and computer program products perform the step of determining whether the data is a taxable asset.

In another aspect of the present invention, methods and computer program products perform the step of determining whether the at least one client transaction has a tax impact. An additional aspect may involve calculating the tax impact of the client transaction(s). This may involve utilizing existing Federal/State tax schedules or other parameters which are provided by the system operator/user etc.

In another aspect of the present invention, methods and computer program products perform the step of determining any discrepancies within the data where the discrepancy determination may involve comparing client data with predetermined parameters. In another aspect, the discrepancies may be determined by querying the system or the system operator/user for certain information and using such information to determine whether a discrepancy exists. The same information may be used to resolve or reconcile the discrepancies. In another aspect, if there is a discrepancy, the system creates a reminder to enter the information at a later date.

In another aspect of the present invention, methods and computer program products perform the step of providing possible counterpart transactions for the client transaction.

In yet another aspect of the present invention, the analysis of the aggregated client financial data may involve determining the change in operating costs and value of a client's real estate assets.

In yet another aspect of the present invention, methods and computer program products perform the step of storing the client financial data in a database.

In yet another aspect of the present invention, methods and computer program products perform the step of alerting an operator/user of the computer data system of missing information, based on predetermined parameters. The operator/user may also be alerted to a discrepancy in the collected data.

In yet another aspect of the present invention, a system with a memory device and a processor disposed in communication with the memory device, performs the management of the client's wealth where the processor may be configured to retrieve client financial data, aggregate client financial data, reconcile client financial data, collect data concerning client transaction(s), create a client commitment schedule, query for additional information concerning a client transaction, analyze the aggregated client financial data, determine relationships between client transactions and determine the format of the aggregated data.

In yet another aspect of the present invention, the system processor may be configured to adjust the commitment schedule.

In yet another aspect of the present invention, the system processor may be configured to determine relationships between transactions based on predetermined parameters.

In yet another aspect of the present invention, the system processor may be configured to determine relationships between transactions by linking newly flagged transactions with previously flagged transactions.

In yet another aspect of the present invention, the system processor may be configured to transform aggregated data into a standardized format where the data is not in a standardized format.

In yet another aspect of the present invention, the system processor may be configured to modify the commitment schedule by determining a new balance for the client and determining what has already been paid by the client.

In yet another aspect of the present invention, the system processor may be configured to generate one or more reports based on the aggregated data.

In yet another aspect of the present invention, the system processor may be configured to determine the types of assets involved in the aggregated data.

In yet another aspect of the present invention, the system processor may be configured to determine whether the data is a taxable asset.

In yet another aspect of the present invention, the system processor may be configured to determine whether the client transaction has a tax impact.

In yet another aspect of the present invention, the system processor may be configured to calculate the tax impact of the client transaction.

In yet another aspect of the present invention, the system processor may be configured to determine any discrepancies within the data.

In yet another aspect of the present invention, the system processor may be configured to determine the discrepancy within the data by comparing client data with predetermined parameters.

In yet another aspect of the present invention, the system processor may be configured to provide possible counterpart transactions for the client transaction.

In yet another aspect of the present invention, the system processor may be configured to analyze the aggregated client financial data by determining the return of investment of the client's investment portfolio.

In yet another aspect of the present invention, the system processor may be configured to analyze the aggregated client financial data by determining the change of basis and value of a client's investments.

In yet another aspect of the present invention, the system processor may be configured to analyze the aggregated client financial data by determining the change in operating cost and value of a client's real estate assets.

In yet another aspect of the present invention, the system processor may be configured to store the client financial data in a database.

In yet another aspect of the present invention, the system processor may be configured to alert an operator/user of the computer data system of missing information, based on predetermined parameters.

In yet another aspect of the present invention, a system with a memory device and a processor disposed in communication with the memory device, performs the management of the client's wealth where the processor may be further disposed in communication with: a first module for analyzing and monitoring financial transactional activity and information, a second module for analyzing and monitoring asset sales and purchases, a third module for analyzing and monitoring investment activity, a fourth module for analyzing and monitoring real estate transactional activity and information, a fifth module for analyzing and monitoring loan activity and information and a sixth module for analyzing and monitoring debt accruals and payments. “Module” as used herein may refer to software, hardware, processors, server etc. or groups of same dedicated to performing the aforementioned tasks.

### BRIEF DESCRIPTION OF THE DRAWINGS

The features and advantages of aspects of the present invention will become more apparent from the detailed description set forth below when taken in conjunction with the claims and drawings, in which like reference numbers indicate identical or functionally similar elements. Additionally, the left-most digit of a reference number identifies the drawing in which the reference number first appears.

FIG. 1 is flow chart illustrating an exemplary overall process undertaken by the system according to an aspect of the present invention.

FIG. 2 is a flow chart illustrating the process of creating a database according to an aspect of the present invention.

FIG. 3. is a flow chart illustrating the process of collecting data including input and/or editing of existing data according to an aspect of the present invention.

FIG. 4 is a flow chart illustrating the process of utilizing forms according to an aspect of the present invention.

FIG. 5. is a flow chart illustrating the process of collecting data including input and/or editing of notes according to an aspect of the present invention.

FIG. 6. is a flow chart illustrating the process of collecting notes or inputting notes into the system according to an aspect of the present invention.

FIG. 7. is a flow chart illustrating the process of collecting data including the compilation of required information, cash information, contact lists, etc. according to an aspect of the present invention.

FIG. 8. is a flow chart illustrating the process of generating equity accounts according to an aspect of the present invention.

FIG. 9. is a flow chart illustrating the process of generating a transactional register according to an aspect of the present invention.

FIG. 10. is a flow chart illustrating the process of collecting data related to non-cash transactions according to an aspect of the present invention.

FIG. 11. is a flow chart illustrating the process of paying bills, invoices etc. according to an aspect of the present invention.

FIG. 12. is a flow chart illustrating the process of making a deposit according to an aspect of the present invention.

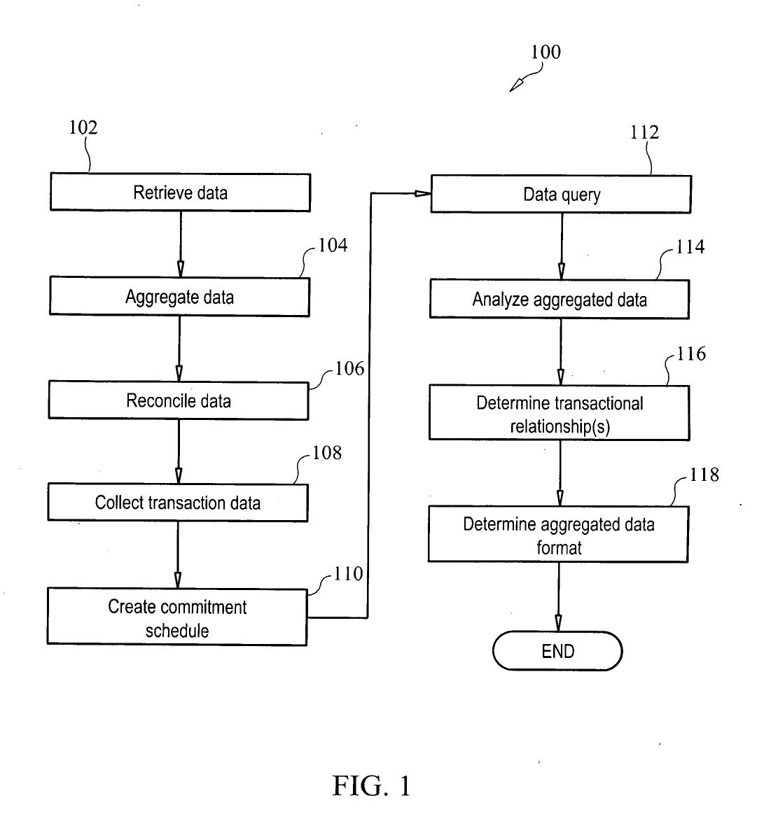

Referring now to FIG. 1, a flow chart illustrating an exemplary overall process 100 undertaken by the system according to an aspect of the present invention is disclosed. In one aspect of the present invention, the system in step 102 may retrieve client information, including financial data, from one or more sources. It should be noted that, in another aspect of the present invention, that the operation may be undertaken by a human operator/users or operator manually or automatically following the operator/user's prompting of the system. The information may be retrieved from bank accounts, trading accounts, or other similar accounts. Following the data retrieval in step 102, the data collected is then aggregated in step 104. In one aspect of an embodiment of the present invention, the data aggregation may be conducted by a system processor which may be configured to determine the types of assets involved in the aggregated data. The aggregation process, in one aspect, may include categorizing the collected data, or segregating the data based on predetermined parameters. In another aspect of the present invention, the analysis of the aggregated client financial data may involve determining the change of basis and value of a client's investments.

Next, the data is reconciled in step 106. Data reconciliation, in one aspect, may include checking the data for missing information. The determination of what may be missing may be based on predetermined criteria programmed into the system or information defined to be necessary by an operator/user on the system.

Transactional data, in step 108, is then collected and stored into the system. Transactional data may include, by way of example, purchases and sales conducted by the client during a given period of time. For example a vehicle purchase and a house sale will then be collected.

In another aspect of the present invention, a commitment schedule as shown in step 110 may be created. A commitment schedule may be an obligatory schedule or timetable of payment undertaken or imposed upon an individual for an asset or an investment. The individual may make a commitment to invest a certain amount over a defined period of time thereby modifying the schedule by deducting the amount paid out from the original total. In one aspect of the present invention, this may be sent out to potential investors as a private equity placement memo, which would outline how much each partner has to commit to. Such a private equity fund would track how much each partner committed to, amount paid thus far and the balance remaining. In another aspect of the present invention, if there is a payout, the system will locate or alert the operator/user that there should be a corresponding transaction for the payout somewhere else. For example, if there is a payout from the client's bank account, a corresponding transaction may be a reduction of the client's commitment schedule.

In another aspect of the present invention, the creation of the commitment schedule may involve determining a new balance for the client. This may include determining, recording and tracking the client's obligation for the commitment along with the payment terms (payment schedule, period of payments, etc.) The analysis of the aggregated client financial data may involve determining the return of investment of a client's investment portfolio. In another aspect of the present invention, methods and computer program products perform the step of adjusting the commitment schedule. In another aspect of the present invention, a system processor may be configured to adjust the commitment schedule. The system processor maybe further configured to modify the commitment schedule by determining a new balance for the client and determining what has already been paid by the client.

Following the creation of a commitment schedule in step 110, the data collected is then queried in step 112 and the aggregated data is analyzed in step 114. In one aspect of the present invention, the system processor during the data aggregation process may be configured to determine whether the data is a taxable asset. In another aspect of the present invention, the system processor may be configured to determine whether the client transaction has a tax impact. In yet another aspect of the present invention, the system processor may be configured to calculate the tax impact of the client transaction.

In another aspect of the present invention, the system processor may be configured to analyze the aggregated client financial data by determining the return of investment of the client's investment portfolio. In yet another aspect of the present invention, the system processor may be configured to analyze the aggregated client financial data by determining the change of basis and value of a client's investments.

In yet another aspect of the present invention, the system processor may be configured to analyze the aggregated client financial data by determining the change in operating cost and value of a client's assets, including without limitation, real estate assets.

Once the data has been aggregated, the system or the operator/user then determines in step 116, the transactional relationships between the collected data. In one aspect of the present invention, the relationships between transactions may be determined by analyses based on predetermined parameters. These parameters may be entered or may be developed by the system based on previous iterations of the system. The system, according to an aspect of the present invention, may prevent an operator/user from arbitrarily entering data without linking such data or associating it with a transaction.

In another aspect of the present invention, the relationships between transactions may be determined by linking newly flagged transactions with previously flagged transactions. For instance, when a client purchases a vehicle for his business, such a transaction may be identified or tagged as a “vehicular transaction”. Any subsequent transaction that may be related to the purchased vehicle, for instance, automobile insurance, will then be identified or tagged as a “vehicular transaction.” This ensures that all related transactions are entered, tracked and recorded properly. In another aspect, the classification may be accomplished by way of different transactional codes for each asset and/or transaction.

In another aspect of the present invention, methods and computer program products perform the step of providing possible counterpart transactions for the client transaction.

In yet another aspect of the present invention, the system processor may be configured to determine relationships between transactions based on predetermined parameters. In yet another aspect of the present invention, the system processor may be configured to determine relationships between transactions by linking newly flagged transactions with previously flagged transactions. In yet another aspect of the present invention, the system processor may be configured to provide possible counterpart transactions for the client transaction.

Following a determination of the transactional relationships in step 116, the system then determines the data format for the aggregated data in step 118. In one aspect of the present invention, methods and computer program products perform the step of transforming the aggregated client data into a standardized format where the data is not in a standardized format. In another aspect of the present invention, the system processor may be configured to transform aggregated data into a standardized format where the data is not in a standardized format. This may be necessary as the data may have been presented in different formats—having been from a variety of sources. In yet another aspect of the present invention, the system processor may be configured to generate one or more reports based on the aggregated data. Optionally, reports may be generated prior to or following the standardization of the data formats in step 118.

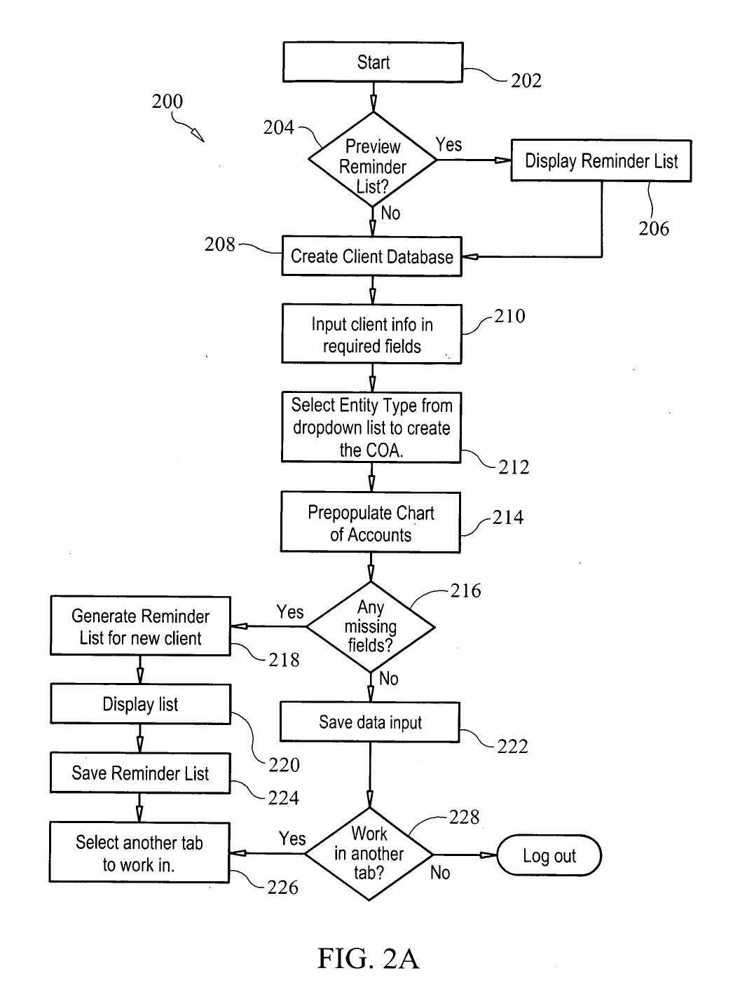

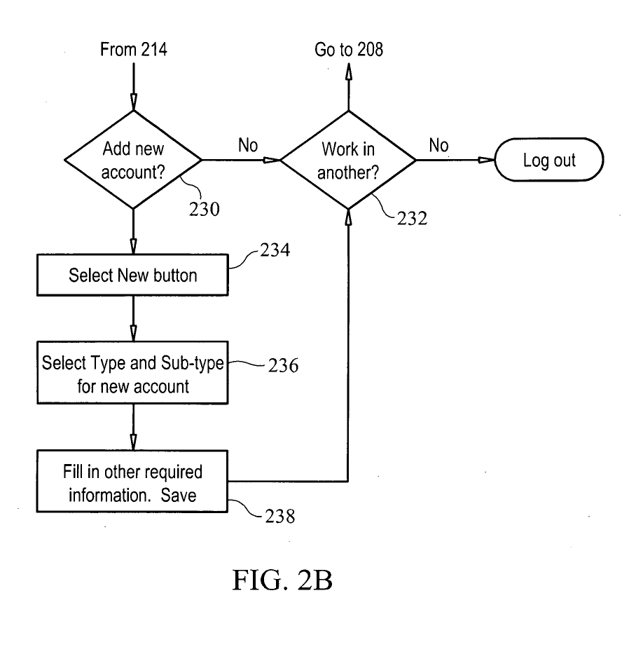

Referring now to FIG. 2A, a flow chart 200 illustrating the process of creating a database according to an aspect of the present invention is shown. The process begins with step 202 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system.

Following step 202, the operator/user or the system determines in step 204 whether to preview the reminder list if previously compiled. The reminder list may be generated and compiled if the system detects the absence of certain information based on predetermined criteria either programmed into the system or determined by the system as a result of the determination of transactional data relationships in step 116 of FIG. 1 above. If the operator/user chooses to do so, the reminder list is then displayed in step 206. Otherwise, the process moves on to the creation of a client database in step 208. The operator/user or the system is then prompted in step 210 to provide client information in required fields. The entity type for the client e.g. Limited Liability Company (LLC), Corporation etc. is then selected next in step 212. Following the entity selection, the client's database may be pre-populated in step 214 with a basic chart of accounts information based on the entity type selected. The system or the operator/user checks in step 216 to see whether there are any missing fields or if some fields were not populated in step 214. If all the fields have been populated, the data is saved in step 222. If not, then a reminder list is generated in step 218 for reminding the operator/user or the system about the fields that were not populated. In one aspect of the present invention, the reminder list may be displayed for an operator/user to view in step 220. The reminder list is then saved in step 224 and the operator/user may then select another facility to work in by selecting a tab on the system screen in step 226. In another aspect of the present invention, following the data save operation in step 222, the operator/user may be enabled in step 228 to work in another facility or to logout. In another aspect of the present invention, and referring to FIG. 2B once the chart of accounts have been pre-populated in step 214, the operator/user or the system may be prompted to add a new account for the client in step 230. If the operator/user opts to add a new account the system in step 234 enables the operator/user to select a new button for the new account. Further along, the operator/user is enabled to select the type of the account and additional sub-types for the account in step 236. Once done, the operator/user is then enabled to enter all required information for the new account. In another aspect of the present invention, where the operator/user opts not to add a new account, the operator/user is queried in step 232 as to whether he/she intends to work in or create another client database. If the operator/user selects to do so, the process moves back to step 208. Otherwise the operator/user may then log out of the system. For operator/user and/or system operations within the process 200, the system is configured to enable all of the above discussed steps.

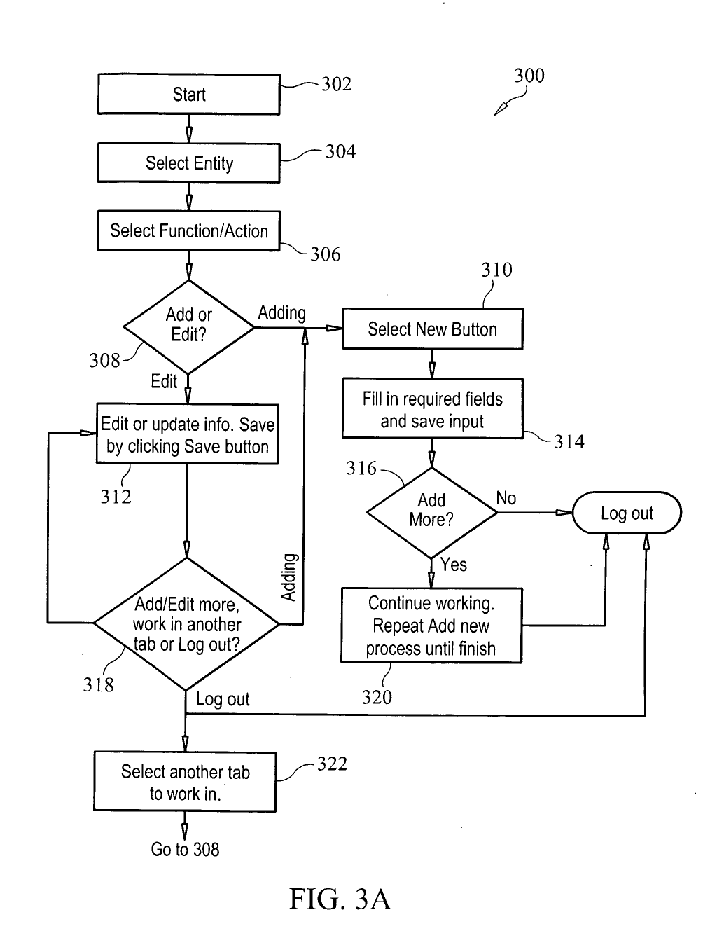

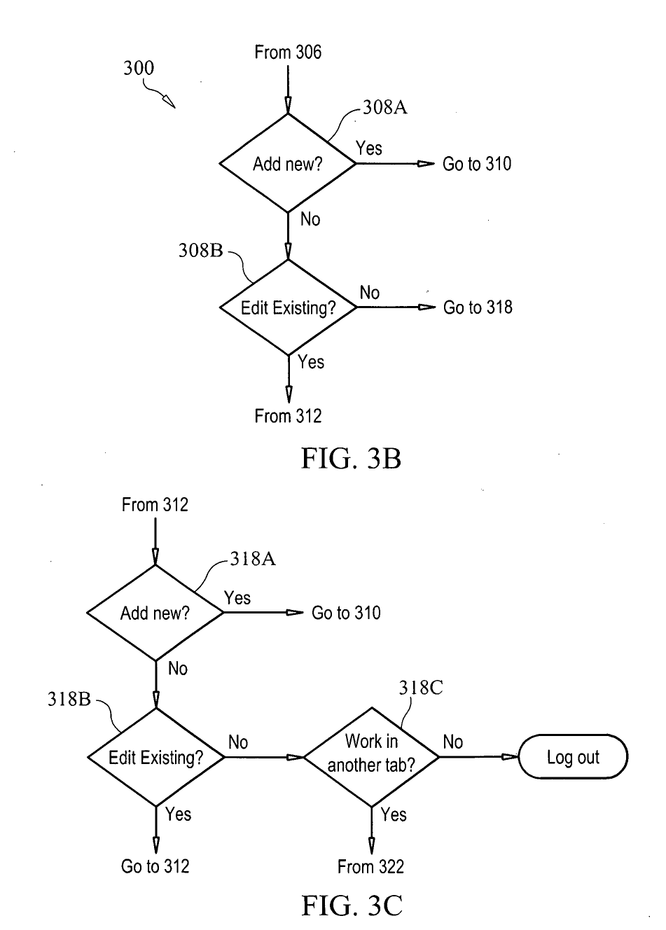

Referring now to FIGS. 3A-3C, flow charts 300 illustrating the process of collecting data including input and/or editing of existing data according to an aspect of the present invention are shown. The process begins with step 302 where an operator/user may log in to the system or in another aspect of the present invention, a system processor begins the process. In another aspect of the present invention, the system processor may begin the process as a result of an automated data retrieval and collection operation. In one aspect of the present invention, such an operation may be by scheduled routine or prompted by an activity or an action within or without the system. The operator/user then selects the entity type involved in step 304. Next, the operator/user determines and/or selects the function/action to be worked on in step 306. In one aspect of the present invention, the function/action may include, but not be limited to: pledges, schedule K−1 data, insurance policies, contact information etc. Once the function/action has been determined/selected in step 306, the operator/user is prompted to decide whether data is being added to the system or existing data is being edited in step 308. In one aspect of the present invention, step 308 made be further broken down into discrete steps as shown in FIG. 3B where the operator/user is asked whether data is being added or not in step 308A. If data is not being added, the operator/user is then queried as to whether existing data is being edited in step 308B. If the data is being edited, the process then proceeds to step 312 where the operator or operator/user is enabled to edit the existing data. Where new data is being added, the process proceeds from step 308A to steps 310/314 where the operator/user is enabled to select a new button for the added data and to enter the data into required fields in step 314. The operator is then queried as to whether more data is to be added in step 316. If not, the operator/user may log out. Otherwise, in another aspect of the present invention, the operator/user may continue working in step 320 until the additions are completed. Following the editing or updating of existing data in step 312, the operator/user may be prompted in step 318 to decide whether more data is to be added, edited or whether the operator wishes to work in another facility (which may be selected from the system screens tabs). Step 318 may be further broken down into its discrete steps as shown in FIG. 3C. In one aspect, the operator/user is queried whether new data or information is being added in step 318A. If so, the process proceeds to step 310, if not, the system proceeds to step 318B where the operator/user is queried as to whether existing information is to be edited. If not then the operator/user in step 318C is queried whether they want to work in another facility. If not, the operator/user may log out of the system. If the operator/user intends to work in another facility, the process proceeds to step 322. Where existing data is to be edited, the process proceeds to step 312.

In another aspect of the present invention, once the operator/user has filled in the required fields in step 314, the system will determine whether certain information or data is missing or whether certain fields have not be filled. In another aspect of the present invention, the system may generate a reminder list for the operator/user to remind them of the missing items. In another aspect of the present invention, the system may make such a determination based on predetermined parameters set in the system.

Referring now to FIG. 4, a flow chart 400 illustrating the process of utilizing forms according to an aspect of the present invention is shown. The process begins with step 402 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system. After the entity type is selected in step 404, the operator/user then in step 406 selects the appropriate form to be used in collecting the client information or data. The operator/user is then in step 410 asked whether the selected form has been pre-populated. In one aspect of the present invention, the selected form may be pre-populated by virtue of the entity type selected. If not, the operator/user is enabled in step 408 to add new forms. The operator/user may then fill in the required fields and then save the form in the same step. The operator/user is then queried whether the required form number is listed. In one aspect of the present invention, exemplary forms used may include tax forms. If the number is listed, the operator/user may in step 412 then repeat the process until all required forms have been selected after which the operator/user is queried whether they intend to work in another facility or log out in step 416. If the required form number is not listed as queried in step 414, the operator/user is enabled to add a form and fill in the required fields in step 418. The data is then saved and the process repeated until all required forms are included (steps 420-426). Once all forms have been selected, added and saved, the process proceeds to step 416 where the operator/user is queried whether they intend to work in another facility or log out. It should be noted that the process shown in FIG. 4 may include certain forms such as tax forms. It should also be noted that the process also extends to other non-tax related forms.

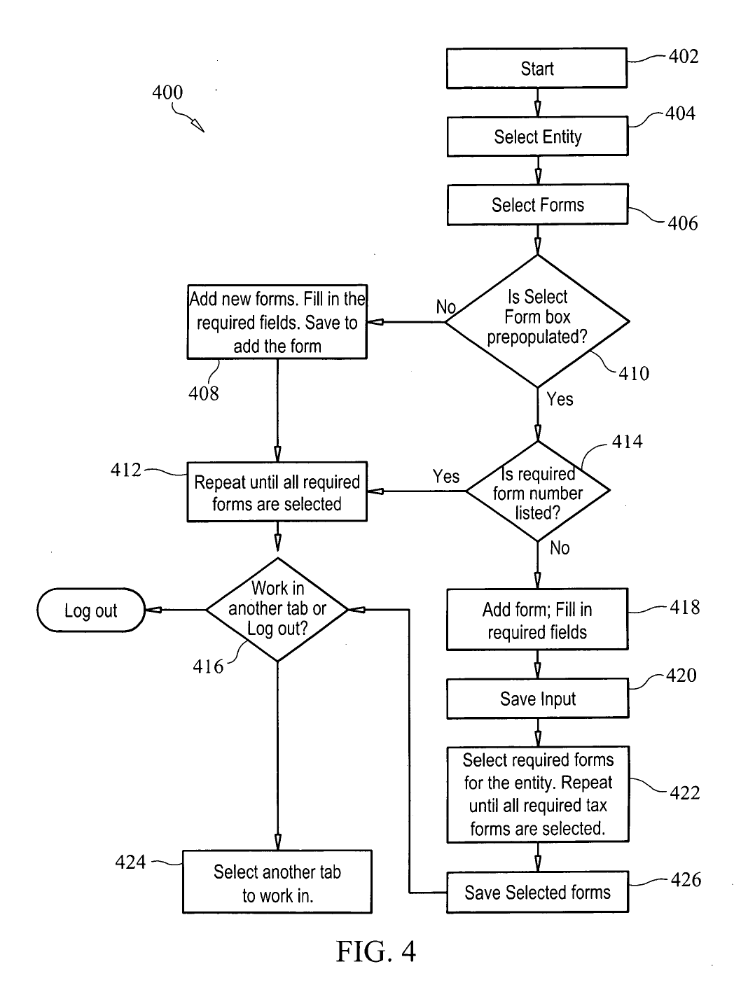

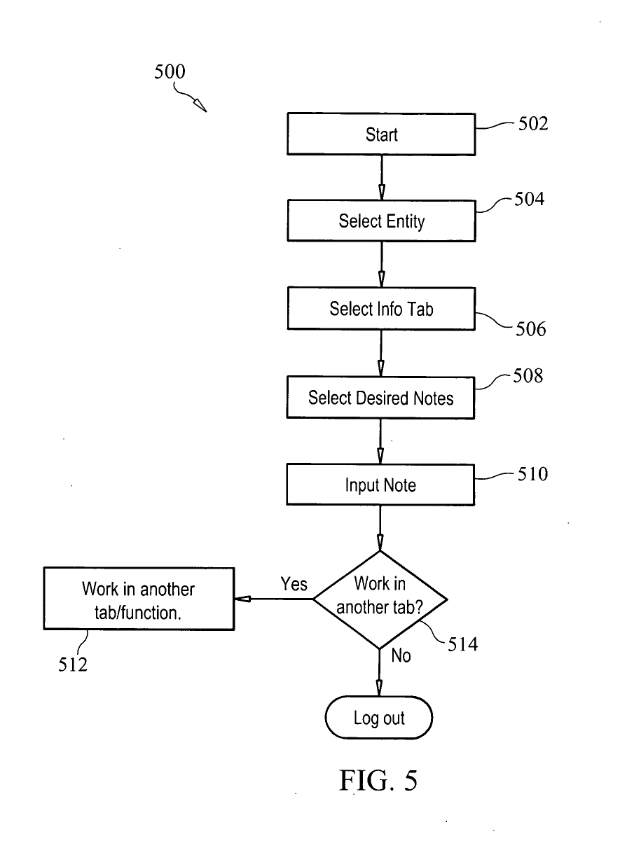

Referring now to FIG. 5, a flow chart 500 illustrating the process of collecting data including input and/or editing of notes according to an aspect of the present invention is shown. Once the process starts at step 502, the operator/user may then select the appropriate entity (step 504), information facility (step 506) and the desired notes (step 508). The operator/user is then enabled to input their notes in the selected facility in step 510 which is also saved in the system. Following this, the operator/user is queried as to whether they intend to work in another tab/facility in step 514. If so, they are then directed and enabled to work in their desired tab/facility in step 512. If not, the operator/user is enabled to log out of the system.

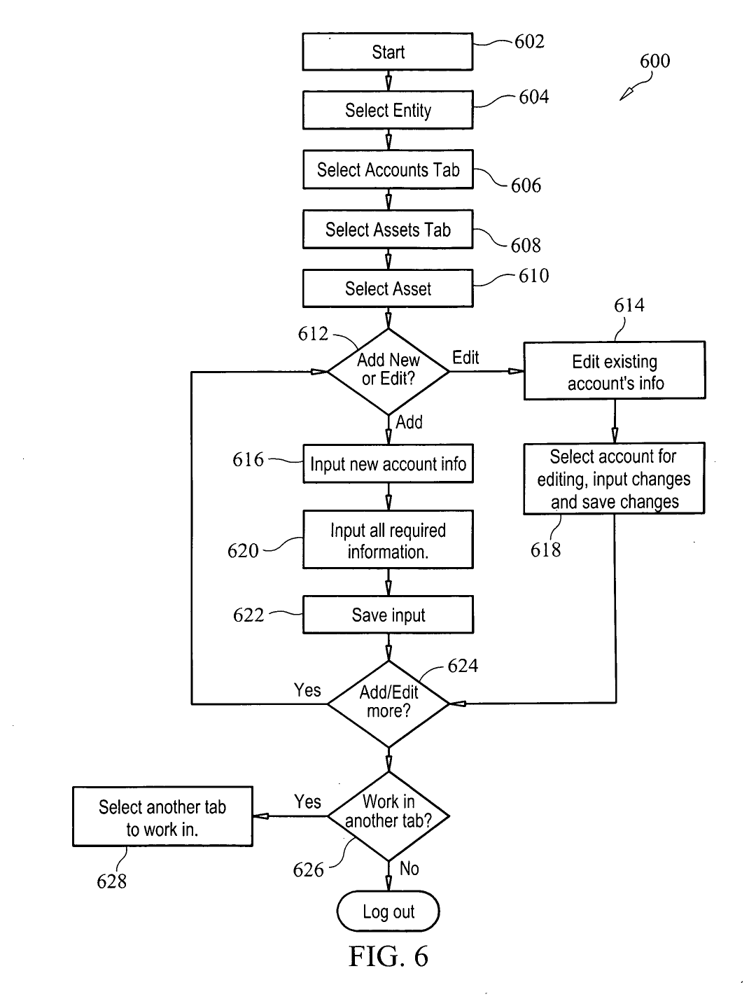

Referring now to FIG. 6, a flow chart 600 illustrating the process of collecting asset/obligation/liability information/data including the compilation of required information, cash information, contact lists, etc. according to an aspect of the present invention is shown. The process begins with step 602 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system. After the entity type is selected in step 604. The operator/user is then enabled to select the accounts facility and then the assets facility (steps 606 & 608) after which the operator/user is enabled to select the specific asset/obligation/liability in step 610. Examples of assets/obligations/liabilities include, without limitation: cash, marketable securities, accounts receivable, notes receivable, equipment, investments, real estate, vehicles, depreciables, collectibles, fine arts, decorative arts, intellectual property, accounts payable, credit cards, notes payable, accrued expenses, taxes payable, mortgages payable, bond payable, etc. Once the specific asset/obligation/liability has been selected, the operator/user in step 612 is prompted to determine whether a new asset/obligation/liability is being added to the system or whether existing assets/obligations/liabilities are to be edited. If they are to be edited, the operator/user is prompted and enabled to edit existing data or information in step 614 and the edited information saved in step 616. If new data is to be added in step 612, the operator/user is enabled to do so in steps 618 and 620. The data is then saved in step 622 and the operator/user is prompted to determine whether more data is to be added or edited in step 624. If so, then the process proceeds to step 612. If not, the process proceeds to step 626 where the operator/user is prompted to decide whether to work in another facility (to step 628) or log out of the system.

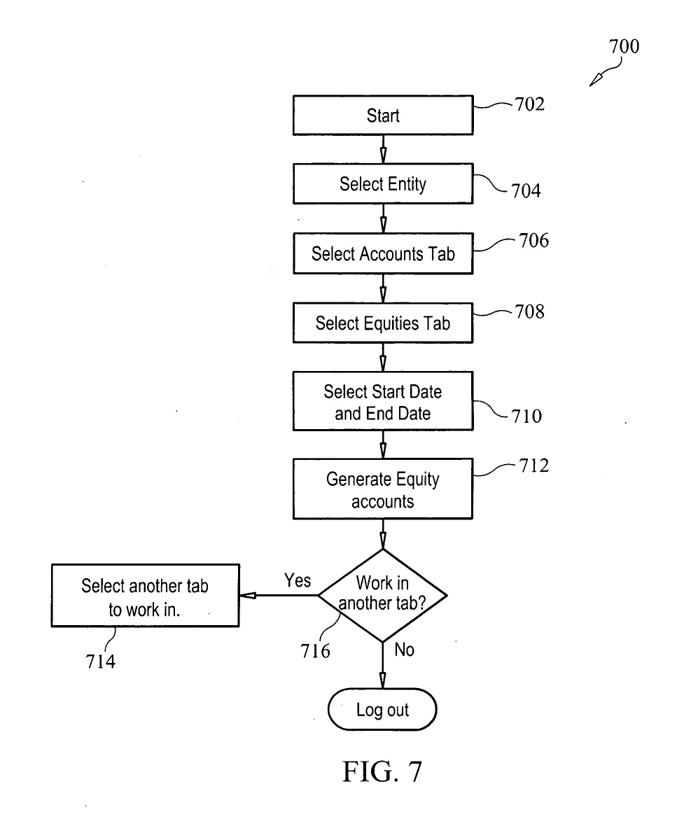

Referring now to FIG. 7, a flow chart 700 illustrating the process of generating equity accounts according to an aspect of the present invention is shown. The process begins with step 702 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system. After the entity type is selected in step 704, the operator/user is enabled to select the accounts facility and then the equities facility (steps 706 & 708). Next, the operator/user in step 710 is enabled to select the start date and end date for the period they are interested. The system, in one aspect of the present invention, then generates the accounts for the equities during that period in step 712. The operator/user may then either view the account or move on to step 716 where the system prompts the operator/user to decide whether to continue working in another facility (step 714) or log out of the system.

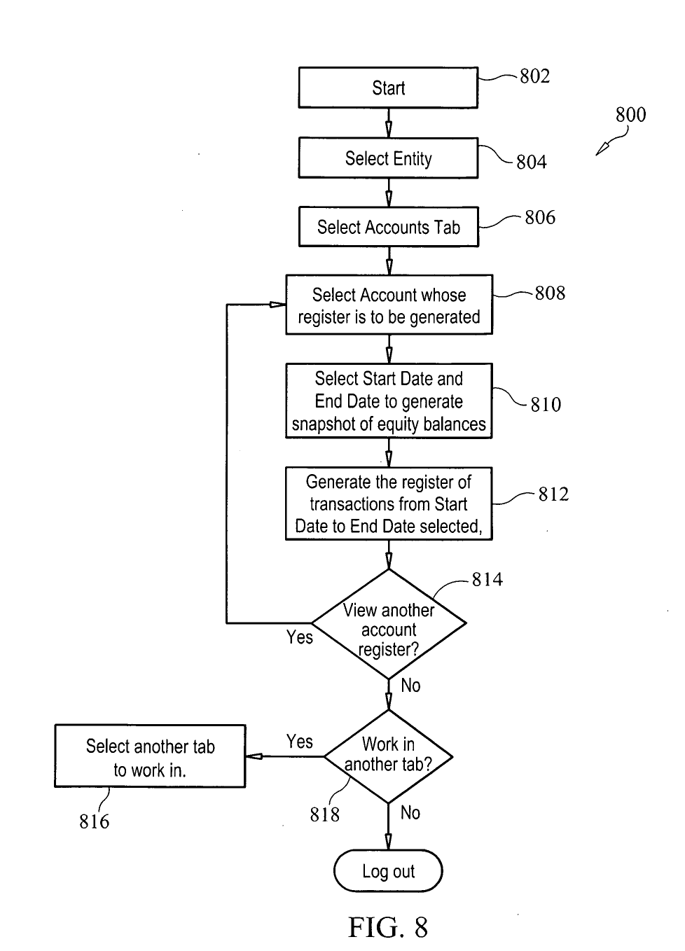

Referring now to FIG. 8, a flow chart 800 illustrating the process of generating a transactional register according to an aspect of the present invention is shown. The process begins with step 802 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system. After the entity type is selected in step 804, the operator/user is enabled to select the accounts facility (step 806). Next, the operator/user in step 808 is enabled to select the account whose register is to be generated. Once the account has been selected, the operator/user is enabled in step 810 to select the start date and end date for the relevant period. The system, in one aspect of the present invention, then generates the accounts for the equities during that period in step 812. The operator/user may then either view another account or register in step 814 or be prompted by the system in step 818 to decide whether to continue working in another facility (step 816) or log out of the system.

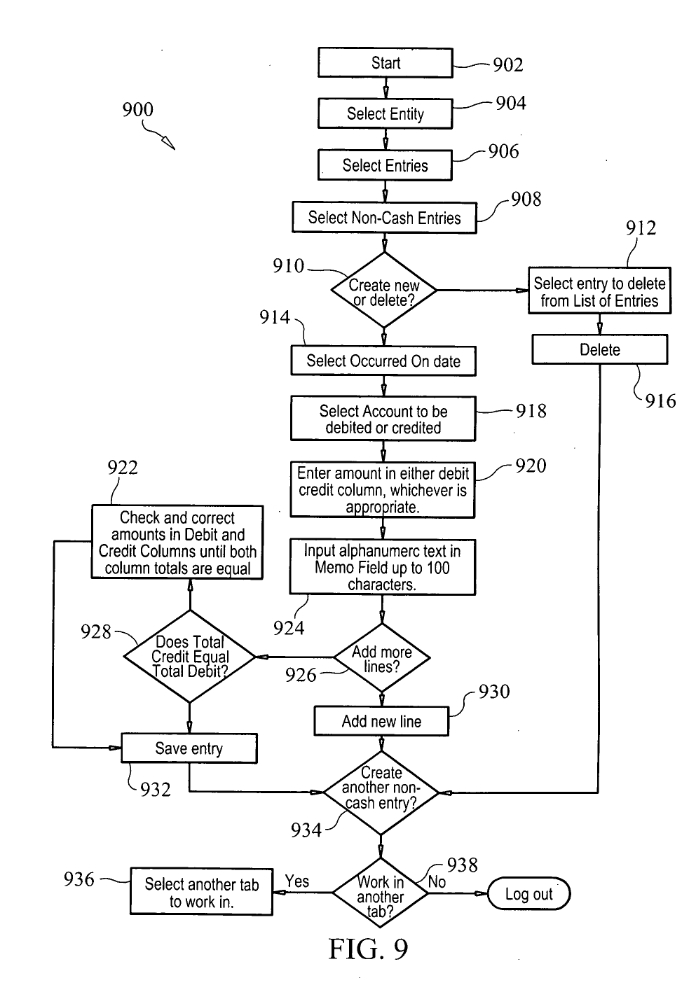

Referring now to FIG. 9, a flow chart 900 illustrating the process of collecting data related to non-cash transactions according to an aspect of the present invention is shown. The process begins with step 902 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system. After the entity type is selected in step 904, the operator/user is enabled to select the entries facility and then the non-cash entries facility (steps 906 & 908 respectively). The operator/user is then prompted to either create or delete a non-cash entry in step 910. If the operator/user intends to delete an entry, the operator/user is enabled to select, in step 912, an entry from a list of entries and then delete the specified entry (step 916) after which the operator/user is queried as to whether a new non-cash entry is to be created (step 934). If the operator/user does not intend to delete a non-cash entry in step 910, then the operator/user is enabled to create an entry by first selecting in step 914 the date the non-cash transaction occurred. Once the date has been selected, the operator/user is enabled to select the account to be debited or credited in step 918. Next, the amount to be debited/credited is entered in step 920. The system, in an aspect of the present invention then enables the operator/user in step 924 to enter a memo concerning the debited/credited entry after which the operator/user is enabled in step 926 to add more lines. If an additional line is sought, the operator/user is then enabled to add a new line in step 930 before the process proceeds to step 934. If no additional lines are sought, the operator/user is further queried as to whether the total credit equals the total debit in step 928. If the totals are not equal then the operator/user is enabled in step 922 to check and correct the amounts until the totals are equal. The data is then saved in step 932 and the operator/user is prompted to decide whether to create another non-cash entry in step 934. If so, then the process moves to step 914. If not, then the system prompts the operator/user to decide whether to continue working in another facility (step 938) or log out of the system.

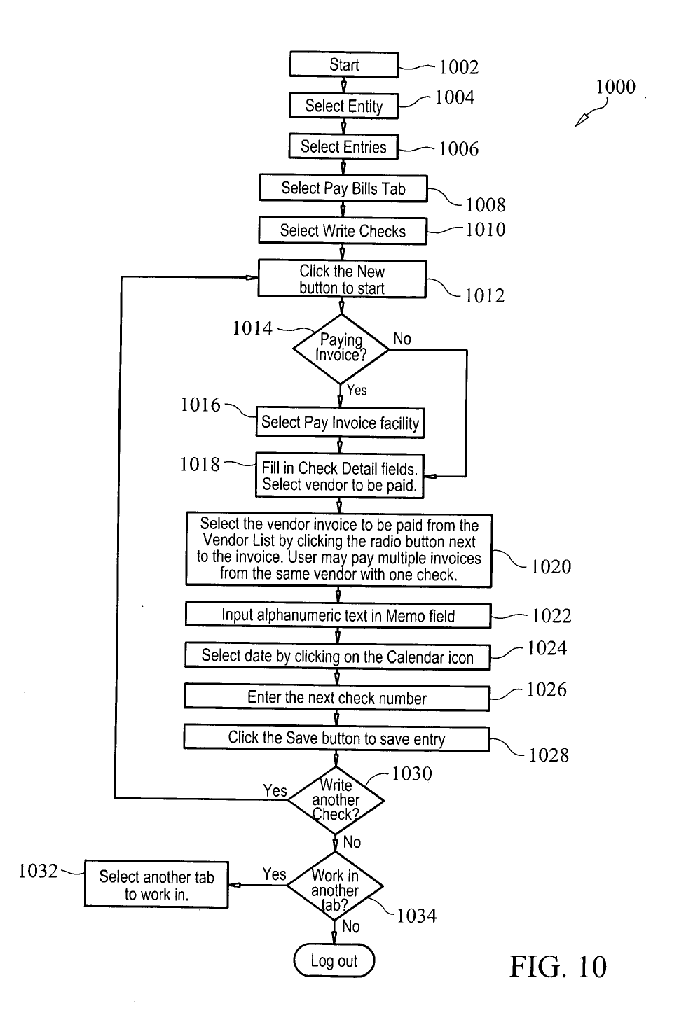

Referring now to FIG. 10, a flow chart 1000 illustrating the process of paying bills, invoices etc. according to an aspect of the present invention is shown. The process begins with step 1002 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system. After the entity type is selected in step 1004, the operator/user is enabled to select the entries facility (step 1006) and then the bills and write checks facilities (steps 1008 & 1010 respectively). The operator/user is then enabled in step 1012 to begin the process of entering the relevant data. In step 1014, the operator/user is prompted to decide whether an invoice is being paid. If an invoice is being paid, then the system enables the operator/user to use the pay invoice facility in step 1016 and then to step 1018. If an invoice is not being paid as determined in step 1014, then the process proceeds to step 1018 where the operator/user enters the relevant information and selects the vendor that is to be paid (step 1020). Next, the operator/user is enabled to input a memo using alphanumeric characters (step 1022), select the relevant date (step 1024), enter the check number (step 1026 and save the entries (step 1028). The system then prompts the operator/user to decide whether to write another check or not (step 1030). If the operator/user intends to do so, the process moves back to step 1012. Otherwise, the system prompts the operator/user to decide whether to continue working in another facility (step 1034) or log out of the system.

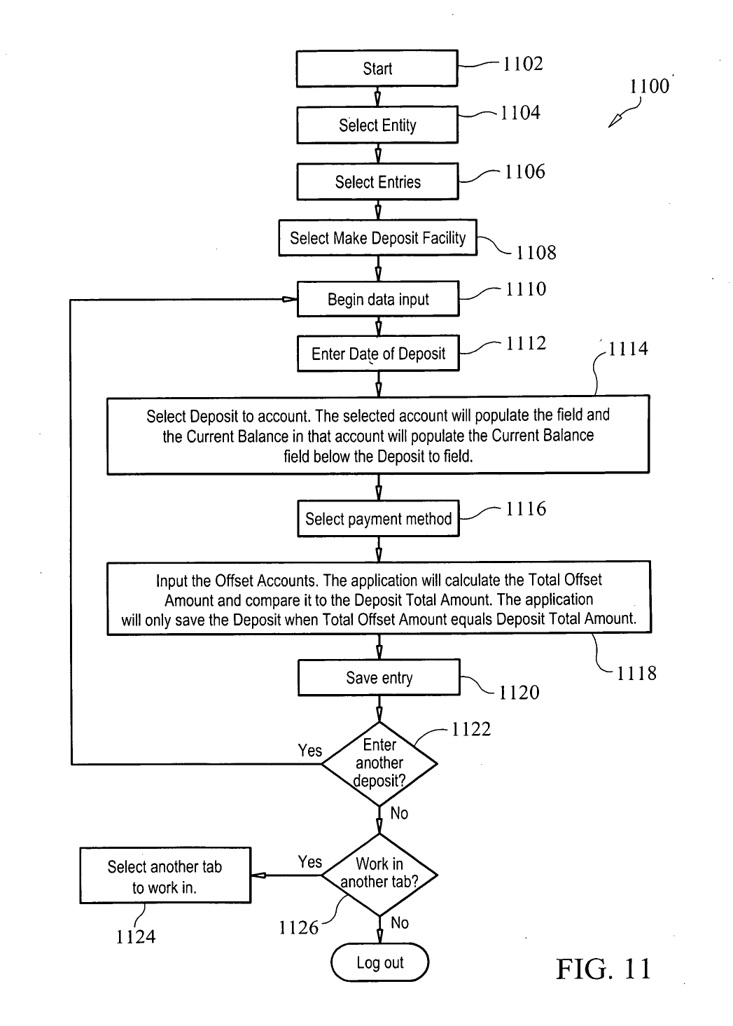

Referring now to FIG. 11, a flow chart 1100 illustrating the process of making a deposit according to an aspect of the present invention is shown. The process begins with step 1102 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system. After the entity type is selected in step 1104, the operator/user is enabled to select the entries facility (step 1106) and then the deposit facility (step 1108). The operator/user is then enabled to begin the data input (step 1110), enter the date of the deposit (step 1112) and select the account to deposit (step 1114). The system then enables the operator/user to select the payment method in step 1116 and then input the offset accounts in step 1118. In an aspect of the present invention, the system will calculate the total offset amount and compare it with the deposit total amount. The system will only save the deposit being made when the total offset amount is equal to the deposit total amount. Once the entry is saved in step 1120, the operator/user is given the choice in step 1122 to enter another deposit or decide in step 1126 to work in another facility in step 1124 or log out of the system.

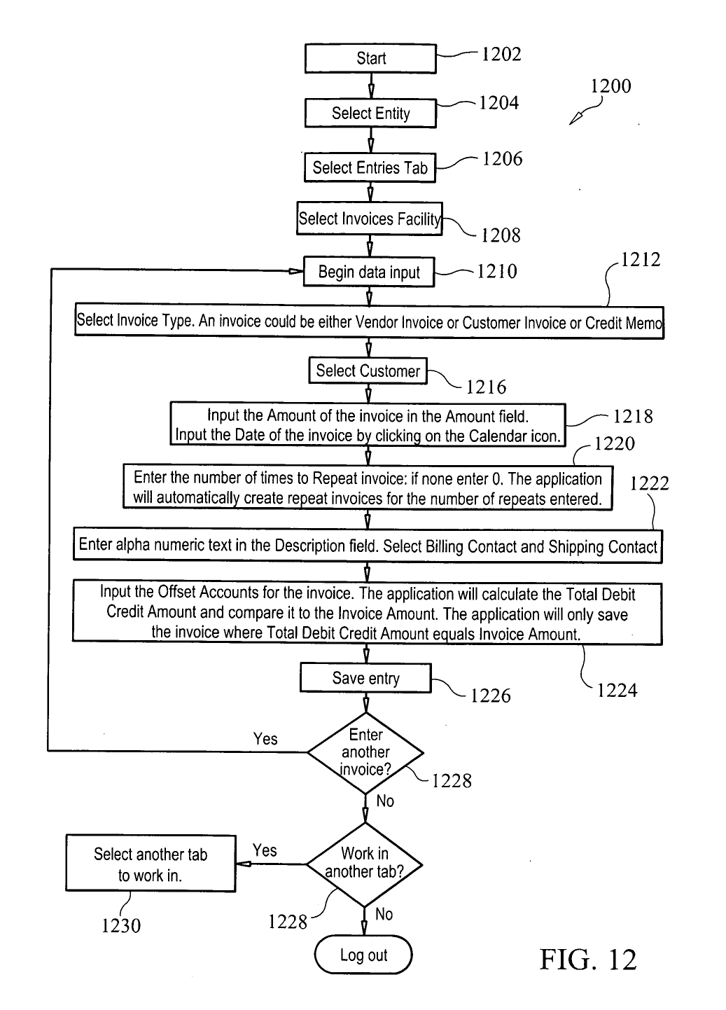

Referring now to FIG. 12, a flow chart 1200 illustrating the process of recording information regarding invoices according to an aspect of the present invention is shown. The process begins with step 1202 where an operator/user may log in to the system or in another aspect of the present invention, a system processor begins the process. In another aspect of the present invention, the system processor may be the operator and may begin the process as a result of an automated data retrieval and collection operation. In one aspect of the present invention, such an operation may be by scheduled routine or prompted by an activity or an action within or without the system. After the entity type is selected in step 1204, the operator/user is enabled to select the entries facility (step 1206) and then the invoices facility (step 1208). The operator/user is then enabled to begin the data input (step 1210), and then select the invoice type in step 1212. The operator/user is then enabled to input the invoice number and customer information into the appropriate fields (step 1214) and then select the customer in step 1216. The amount of the invoice is entered in step 1218 and the number of times to repeat the invoice (in one aspect as a reminder to the customer) is indicated in step 1220. For additional invoice information, the operator/user is enabled to enter text including billing and contact information in step 1222 along with the offset accounts for the invoice (step 1224). The entry is then saved in step 1226 and the operator/user is given the choice in step 1228 to enter another invoice or decide in step 1232 to work in another facility in step 1230 or log out of the system.

While various aspects of the present invention have been described above, it should be understood that they have been presented by way of example, and not limitation. It will be apparent to persons skilled in the relevant art(s) that various changes in form and detail can be made therein without departing from the spirit and scope of aspects of the present invention. Thus, aspects of the present invention should not be limited by any of the above described exemplary aspects, but should be defined only in accordance with the following claims and their equivalents.

In addition, it should be understood that the figures in the attachments, which highlight the structure, methodology, functionality and advantages of aspects of the present invention, are presented for exemplary purposes only.

The invention claimed is:

1. A method of real-time wealth management using a computer data system comprising:
retrieving client financial data from at least one source;
aggregating client financial data from said at least one source;
reconciling client financial data;
collecting data concerning at least one client transaction;
creating a client commitment schedule;
querying for additional information concerning a client transaction;
analyzing said aggregated client financial data;
determining any discrepancies within said data.
determining whether said at least one client transaction has a tax impact.
determining relationships between client transactions; and
determining the format of said aggregated data.

2. The method according to claim 1 further comprising adjusting said commitment schedule.

3. The method according to claim 1 wherein said relationships between client transactions is determined by predetermined parameters.

4. The method according to claim 1 wherein the relationships between transactions is determined by linking newly flagged transactions with previously flagged transactions.

5. The method according to claim 1 further comprising transforming said aggregated client data into a standardized format where said data is not in a standardized format.

6. The method according to claim 1, wherein said creation of a commitment schedule further comprises determining a new balance for the client.

7. The method according to claim 1 further comprising generating at least a report based on the aggregated data.

8. The method according to claim 1 further comprising determining the types of assets involved in the aggregated data.

9. The method according to claim 8 further comprising determining whether income from the asset is taxable or whether it is deductible.

10. The method according to claim 10 further comprising calculating the tax impact of said at least one client transaction.

11. The method according to claim 1, wherein said discrepancy determination comprises comparing client data with predetermined parameters.

12. The method according to claim 1 further comprising providing possible counterpart transactions for said at least one client transaction.

13. The method according to claim 1 wherein the analysis of said aggregated client financial data comprises of determining the return of investment of said client's investment portfolio.

14. The method according to claim 1 wherein the analysis of said aggregated client financial data further comprises determining the change of basis and value of a client's investments.

15. The method according to claim 1 wherein the analysis of said aggregated client financial data further comprises determining the change in operating cost and value of a client's real estate assets.

16. The method according to claim 1 further comprising storing said client financial data in a database.

17. The method of claim 1 further comprising alerting an operator/user of said computer data system of missing information, based on predetermined parameters.

18. A computer program product comprising a computer usable medium having control logic stored therein for causing a computer to manage an individual's wealth, said control logic comprising:
first computer readable program code means for retrieving client financial data from at least one source;
second computer readable program code means for aggregating client financial data from at least one source;
third computer readable program code means for reconciling client financial data;
fourth computer readable program code means for collecting data concerning at least one client transaction;
fifth computer readable program code means for creating a client commitment schedule;
sixth computer readable program code means for querying for additional information concerning a client transaction;
seventh computer readable program code means for analyzing said aggregated client financial data;
eighth computer readable program code means for determining relationships between client transactions; and
ninth computer readable program code means for determining the format of said aggregated data.

19. The computer program product of claim 18 further comprising tenth computer readable code means for adjusting said commitment schedule.

20. The computer program product of claim 18 wherein the computer readable program code means determines the relationships between transactions based on predetermined parameters.

21. The computer program product of claim 18 wherein the computer readable program code means determines the relationships between transactions by linking newly flagged transactions with previously flagged transactions.

22. The computer program product of claim 18 further comprising tenth computer readable code means for transforming aggregated data into a standardized format where the data is not in a standardized format.

23. The computer program product of claim 18, further comprising computer readable code means for determining a new balance for the client.

24. The computer program product of claim 18 further comprising tenth computer readable code means for generating at least a report based on the aggregated data.

25. The computer program product of claim 18 further comprising tenth computer readable code means for determining the types of assets involved in the aggregated data.

26. The computer program product of claim 25 further comprising computer readable code means for determining whether the data is a taxable asset.

27. The computer program product of claim 18 further comprising tenth computer readable code means for determining whether said at least one client transaction has a tax impact.

28. The computer program product of claim 27 further comprising computer readable code means for calculating the tax impact of said at least one client transaction.

29. The computer program product of claim 18 further comprising tenth computer readable code means for determining any discrepancies within the data.

30. The computer program product of claim 18 further comprising computer readable code means for comparing client data with predetermined parameters.

31. The computer program product of claim 18 further comprising tenth computer readable code means for providing possible counterpart transactions for said at least one client transaction.

32. The computer program product of claim 18 further comprising computer readable code means for determining the return of investment of said client's investment portfolio.

33. The computer program product of claim 18 further comprising computer readable code means for determining the change of basis and value of a client's investments.

34. The computer program product of claim 18 further comprising computer readable code means for determining the change in operating cost and value of a client's real estate assets.

35. The computer program product of claim 18 further comprising computer readable code means for storing said client financial data in a database.

36. The computer program product of claim 18 further comprising computer readable code means for alerting an operator/user of said computer data system of missing information, based on predetermined parameters.

37. The system for real-time wealth management comprising:
a. a memory device; and
b. a processor disposed in communication with said memory device, the processor configured to:
i. retrieve client financial data from at least one source;
ii. aggregate client financial data from at least one source;
iii. reconcile client financial data;
iv. collect data concerning at least one client transaction;
v. create a client commitment schedule;
vi. query for additional information concerning a client transaction;
vii. analyze said aggregated client financial data;
viii. determine relationships between client transactions; and
ix. determine the format of said aggregated data.

38. The system according to claim 37 wherein said processor is configured to adjust said commitment schedule.

39. The system according to claim 39 wherein said processor is configured to determine relationships between transactions based on predetermined parameters.

40. The system according to claim 37 wherein said processor is configured to determine relationships between transactions by linking newly flagged transactions with previously flagged transactions.

41. The system according to claim 37 wherein said processor is configured to transform aggregated data into a standardized format where the data is not in a standardized format.

42. The system according to claim 37 wherein said processor is configured to create said commitment schedule comprises by determining a new balance for the client.

43. The system according to claim 37 wherein said processor is configured to generate at least a report based on the aggregated data.

44. The system according to claim 37 wherein said processor is configured to determine the types of assets involved in the aggregated data.

45. The system according to claim 44 wherein said processor is configured to determine whether the data is a taxable asset.

46. The system according to claim 37 wherein said processor is configured to determine whether said at least one client transaction has a tax impact.

47. The system according to claim 46 wherein said processor is configured to calculate the tax impact of said at least one client transaction.

48. The system according to claim 37 wherein said processor is configured to determine any discrepancies within the data.

49. The system according to claim 48, wherein the processor determines said discrepancy by comparing client data with predetermined parameters.

50. The system according to claim 37, wherein said processor is configured to provide possible counterpart transactions for said at least one client transaction.

51. The system according to claim 37, wherein said processor analyzes said aggregated client financial data by determining the return of investment of said client's investment portfolio.

52. The system according to claim 37, wherein said processor analyzes said aggregated client financial data by determining the change of basis and value of a client's investments.

53. The system according to claim 37 wherein said processor is configured to analyze said aggregated client financial data by determining the change in operating cost and value of a client's real estate assets.

54. The system according to claim 37 wherein said processor is configured to store said client financial data in a database.

55. The system according to claim 37 wherein said processor is configured to alert an operator/user of said computer data system of missing information, based on predetermined parameters.
